(19) United States
(12) Patent Application Publication
(10) Pub. No.: US 2004/0213652 A1
(43) Pub. Date: Oct. 28, 2004

(54) Cargo transfer system using a palletized container

(76) Inventors: Tom Campbell, Ridgedale, MO (US); Art Shoener, Fishers, IN (US)

Correspondence Address: Daniel H. Shulman, Mayer, Brown, Rowe & Maw LLP, P.O. Box 2828, Chicago, IL, 60690-2828, US

(21) Appl. No.: 10/775,258

(22) Filed: Feb. 10, 2004

Related U.S. Application Data
(63) Continuation-in-part of application No. 10/126,290, filed on Apr. 19, 2002, now abandoned.

(51) Int. Cl. B65G 67/00

(52) U.S. Cl. 414/398

(57) ABSTRACT

Disclosed is a system for centralized transfer of cargo to and from rail cars comprising a first railway to accommodate the rail cars; a staging area; and a second railway positioned between the first railway and the staging area to accommodate a movable transfer dock; wherein the cargo is transferred between the staging area and the rail cars via the movable transfer dock. Also disclosed is a cargo container system is provided comprising a rail car having a conveyor means on the floor thereof, a palletized cargo container specifically adapted for shipping cargo in a rail car comprising a base, two side walls extending upward from the base, a platform secured to the side walls and an open top, and wherein the palletized cargo container is movable on the conveyor means.

This application is a continuation-in-part of U.S. application Ser. No. 10/126,290, filed Apr. 19, 2002.

### BACKGROUND OF THE INVENTION

1. Field of the Invention

The present invention relates to cargo transfer system using a palletized container. Particularly, the present invention is directed to an improved system for the transport of cargo between road and rail utilizing a palletized container that allows for efficient loading and unloading of cargo.

2. Description of Related Art

The use of railways to transport cargo has long been known in the art. Railway transport has the advantage that large amounts of cargo may be transferred on more or less direct routes between rail served origin and destination locations. This has long provided shippers with lower transportation costs due to the economies of scale over road transportation alternatives.

Although rail does provide shippers with a cost advantage over trucks in transporting goods, typical rail service takes longer and is less reliable than the highway alternative. This is due in part to the extensive car handling processes required by one or more rail-lines to deliver railcars from an origin to a destination point. Additional time is also often lost due to the manual loading and unloading processes of both shippers and customers alike. The combination of these factors not only affects service but also has a direct impact on car utilization and additional revenue opportunities.

Also complicating the rail service alternative is that not all shippers or customers have direct rail access. This, coupled with the demand for service reliability and increased equipment utilization, has driven the need for a form of hybrid transportation utilizing a combination of both rail and truck delivery.

This hybridized transportation solution has evolved in one of three ways. One such solution utilizes common distribution or receiving docks where cars can be switched and spotted and cargo transferred between cars and trucks for delivery. Rail is typically used for the long haul while trucks are used for the short haul either bringing cargo from a shipper to a common distribution center or picking up cargo from a common receiving center and delivering to final destinations. An example of this type of facility is with the shipment of new automobiles where autos are loaded onto specialized auto-rack freight cars at vehicle manufacturing centers and moved via rail to large centralized distribution centers. In this example, autos are then offloaded from the railcars into specialized automobile transport trailers for truck deliveries to local automobile dealers.

The use of the common facility is unsuitable, however, in the typical loading dock operation where goods are shipped utilizing conventional refrigerated or dry boxcars. In that case, re-spotting of cars is often necessary since the docks are stationary and of varying size and configuration. Cars must often be moved to accommodate dockside door locations or to continue the load/unload process. Additionally, loading and unloading of cargo still involves a manual process requiring hand stacking and removal of goods inside the cars or the use of personnel operated fork trucks to handle palletized goods in and out of the car. In some instances, only a portion of the car capacity can be utilized due to the stacking limitations of cargo. In any case, the process is labor intensive, time consuming, and often results in damage to goods or equipment.

A second prior solution is an intermodal process utilizing centralized receiving and distribution centers where truck trailers or cargo containers are trucked in and out and loaded on or unloaded from specially designed rail cars. This is accomplished through the use of large moveable overhead cranes where the trailers or containers are lifted on and off the rail car. Some facilities also utilize specially designed ramps where trailers can be driven directly onto or off specially equipped flat cars. With this process, however, only a maximum of two trailers or two containers can be placed on each rail car. Moreover, the use of specialized crane equipment is both expensive and dangerous. Finally, because of the size and cost of the machinery needed to operate a large intermodal complex, not all depots can be outfitted for this type of transfer arrangement. Accordingly, efficient transfer of cargo is not always achieved.

The third known alternative is the use RoadRailers®, i.e., truck trailers fitted with specially designed running gear so they can operate on both highways and railroad tracks. These trailers are trucked to loading stations where they are placed on railroad tracks and converted for rail operation. Once delivered, the trailers are then converted back to highway service and transported to final customer destinations. Again, this process enables only one trailer load of goods to be delivered at a time. Moreover, the use of RoadRailers® is not common, and outfitting an entire trucking fleet with RoadRailer® units is a costly expense for a trucking company. Finally, not all depots are outfitted to accommodate RoadRailers®.

A need exists in the art for a system that can be more cheaply implemented at existing railroad depots and that requires minimal, if any, modification to current railway and trucking equipment.

Yet another problem in the current state of the art is that there lacks an efficient system for transporting palletized freight. Palletized freight is currently being transported in a variety of ways using railroad freight equipment. This includes the limited use of railroad flat cars where palletized loads are loaded via fork trucks or other lifting devices onto the deck of the car and secured for shipping. These types of palletized loads usually have odd sized dimensions that require the use of an open vehicle for loading since they will not fit into a standard boxcar for shipment. Typically these loads do not require protection and are transported fully exposed to the elements. However, in some instances, the loads may be covered or crated as a means of protecting the products during shipping.

Palletized loads are primarily transported on flat cars through the use of containers on flat cars or trailers on flat cars. In these instances, palletized loads are placed in enclosed containers or truck trailers, which are then transferred to specially designed flat cars for shipment. Typically, palletized loads are placed in the container or trailer using fork trucks to load the pallets through a door opening at one end of the container or trailer. Pallets are arranged as a single tier the length of the container or trailer. In other instances, palletized loads are “double stacked” by placing palletized loads directly on top of one another.

In addition, palletized loads can be placed in a RoadRailer®.

However, shipment of palletized loads is restricted when using the above alternatives. This is due to the height of the containers or trailers, which must conform to current highway safety standards since the containers or trailers will be transported on hard surface roads. This also applies to the rail operation as well since height dimensions are critical when traveling through tunnels, stations or other such obstructions.

This in turn, limits the height of individual palletized loads placed into the containers or trailers since they must ultimately conform to the interior (height) dimension of the transport vehicle. In addition, containers and trailers are also restricted by the weight of the loads, which, also must conform to current highway safety standards. Oftentimes, the vehicles will “weight out” before they “cube out.” This simply means that individual palletized loads are too heavy to effectively fill the contents of the trailer or container before the weight limitation is reached. Therefore, palletized products loaded into trailers, containers, and RoadRailers® must be relatively lightweight when attempting to utilize the full capacity of the vehicle by double stacking palletized loads.

Palletized loads are also moved by a variety of freight boxcar configurations. This includes cars of varying dimensions, door configurations and thermal considerations. In all cases, palletized loads are placed into the car using either hand operated or fully mechanized fork truck devices. Individual palletized products are loaded and unloaded by moving in and out of the car through a side door opening. This is often a time consuming process since each palletized load must be handled individually in and out of the car by the fork truck. Products are often damaged as a result of the excessive handling or because of limited fork truck maneuverability inside the car. In addition, the freight car sides, roof, doors and door openings are also often damaged during the loading and unloading process.

Palletized products are arranged in a single tier the length of the car and are secured for shipment using tie down straps or a variety of other load divider/securement devices. This is to prevent movement or shifting of the loads during rail transport. The securement devices themselves are often problematic due to loss and damage as well as potentially dangerous situations, which occur with the use of larger, more complex load divider systems.

Single tiering of palletized loads usually occurs when products are heavy or fragile and cannot be stacked on top of one another without damaging the bottom layer. This results in inefficient utilization of freight car capacity with often more than half of the railcar going unused. Sometimes this is avoided by hand stacking similar goods on top of the single tier to an acceptable level or by stacking lighter weight palletized products on top of the first tier. In either case, the loading can become more time consuming and more complicated.

Double stacking of palletized loads usually occurs when the products are lighter weight and can be stacked without crushing or damaging the first tier of products or the products are not susceptible to weight related damage. In some instances, the products are crated or reinforced in some manner to provide the necessary support for two-tier loading.

Another variation employs the use of a second tier platform, which is placed over the first tier of pallets after they have been loaded. Typically, two pallets of products are placed side by side at one end of the car. Then, second tier platform sections are placed over the first tier spanning the distance between the two sidewalls of the car. These sections are supported by structural members extending to the floor at the sidewalls of the car or attached directly to the sidewalls, thus eliminating any pressure on the bottom loads. This then enables a second tier of pallets to be loaded on the platform constructed above the first two pallets of products.

However, all of the current stacking methods risk damage to the cargo, either through human error where hand-stacking is involved, or through damage caused by the use of fork trucks to stack the cargo into the rail car.

The second tier sections utilized to span the distance between the side-walls may include simple 2×10 lumber, common metal floor grating, or more elaborate designs involving drop down sections which fold against the side of the car when not in use.

Most of the perishable products shipped in thermally controlled railcars are hand-stacked to maintain uniform temperature control around the product. These products are also often sensitive to weight limitations due to the delicate nature of the products and packaging involved. An exception would be the shipment of frozen products where air circulation is not as critical and double stacking of pallets may be feasible. This is because the frozen products are less susceptible to load crushing.

However, some palletized loads are being shipped either in a single-tier configuration inside the refrigerated freight car or by double-tiering the loads as previously discussed. This occurs when temperature control around the product is less sensitive (i.e., frozen products) or when load crushing is not an issue with the products involved. Cardboard slip-sheets are often used in place of common wood pallets to minimize load damage and minimize expense to the shipper. Pallets constructed of other materials and heights may also be used as required.

Two tier loading is accomplished in the same manner as described previously with palletized or slip sheeted loads handled individually in and out of the freight car with the use of manually operated fork trucks. However, this system has the disadvantages previously discussed.

Thus, a need exists for an efficient system for palletized loading of a rail car that is adaptable to refrigerated or dry cargo, makes efficient use of the space in the rail car, and facilitates loading and unloading without damaging the cargo.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

It is an object of embodiments of the invention to provide an efficient centralized cargo transfer system. It is a further object of embodiments of the invention to provide an apparatus that can be used to facilitate the transfer of cargo on and off rail cars. It is a further object of the invention to provide a system to facilitate the transfer of palletized cargo on and off of rail cars without damage to the cargo. A particular object of embodiments of the invention is a palletized cargo system that facilitates loading and unloading without the need for a fork truck to handle individual cargo containers. These and other objects may be achieved through embodiments of the invention as described herein.

One embodiment of the invention is a movable transfer dock. A feature of this embodiment is a movable platform having a conveyor means thereon for facilitating movement of cargo atop the transfer dock. In use, the transfer dock is movable along a rail system positioned between rails cars and a staging area. Cargo can be, in one instance, unloaded from a truck and easily transferred, via the conveyor means, across the transfer dock directly into rail cars. In further embodiments, the transfer dock is movable to transfer cargo from one staging area to upstream or downstream rail cars. In other embodiments, the cargo is unloaded into cargo containers that are moved across the transfer dock and loaded directly into the rail car or truck using a container handling system.

In other embodiments of the invention, the transfer dock comprises an enclosure unit assembled to the platform to create a partially or fully enclosed unit. The transfer dock may then be air conditioned to accommodate the transfer of cargo between, for example, refrigerated rail cars and refrigerated trucks. The transfer dock may also include expandable seals for positioning between the doors of the enclosure unit and the applicable rail car and truck, as may be necessary, for example, to avoid the waste of energy if both the rail car or truck and transfer dock are refrigerated. In alternative embodiments, the transfer dock may be motorized to facilitate its movement along a rail way.

Through the use of one or more of the above described embodiments of the invention, a centralized depot can be created that is capable of accommodating disparate cargo from numerous trucks and rail cars and efficiently transferring that cargo to the appropriate rail car or truck.

In brief, one embodiment of the invention is a system for centralized transfer of cargo to and from rail cars comprising a first railway to accommodate the rail cars; a staging area; and a second railway positioned between the first railway and the staging area to accommodate a movable transfer dock; wherein the cargo is transferred between the staging area and the rail cars via the movable transfer dock.

Briefly, another aspect of the invention is a movable transfer dock for facilitating the transfer of cargo between a staging area and a rail car, comprising a movable platform having a conveyor means thereon.

It is yet a further object of the invention to provide an efficient system for loading a rail car that is adaptable to refrigerated cargo, makes efficient use of the space in the rail car, and facilitates loading and unloading without damaging the cargo, either through hand stacking or the use of a fork truck.

In brief, another aspect of the present invention is provided in an embodiment in which a cargo container system is provided comprising a rail car having a conveyor means on the floor thereof, a palletized cargo container specifically adapted for shipping cargo in a rail car comprising a base, two side walls extending upward from the base, a platform secured to the side walls and an open top, and wherein the palletized cargo container is movable on the conveyor means.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the features and embodiments of the invention. Together with the description, the drawings serve to explain the principles of the invention.

### BRIEF DESCRIPTION OF THE DRAWINGS

FIG. 1 is a representation of a central transfer facility in accordance with an embodiment of the invention.

FIG. 2A is a side view of an embodiment of a movable transfer dock in accordance with the present invention.

FIG. 2B is a top plan view of an embodiment of a movable transfer dock in accordance with the present invention.

FIG. 3 is a side view of a door of an embodiment of a movable transfer dock in accordance with the present invention.

FIG. 4A is one side view of an embodiment of a conveyor means and palletized cargo container in accordance with the present invention.

FIG. 4B is another side view of the embodiment of the conveyor means and palletized cargo container in accordance with the present invention as depicted in FIG. 4A.

FIG. 5A is a representation of a movable transfer dock in use at a central transfer facility in accordance with an embodiment of the present invention.

FIG. 5B is a representation of a movable transfer dock in use at a central transfer facility in accordance with an embodiment of the present invention.

FIG. 5C is a representation of a movable transfer dock in use at a central transfer facility in accordance with an embodiment of the present invention.

FIGS. 6A-6D are embodiments of the present invention depicting a means for temporarily securing the movable transfer dock to at least one of the rail cars.

### DETAILED DESCRIPTION OF THE PREFERRED EMBODIMENT

Reference will now be made in detail to the present preferred embodiments of the invention, examples and aspects of which are illustrated in the accompanying drawings. The features and elements of different embodiments of the invention will be described in conjunction with the detailed description provided below.

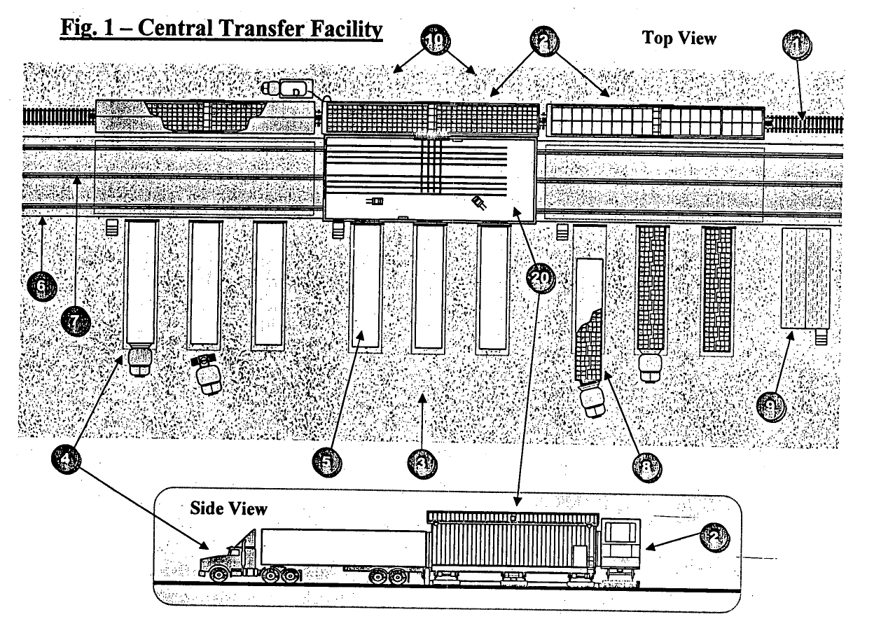

The invention presented herein may be used for centralized cargo transfer. The present invention is particularly suited for centralized cargo transfer between rail and truck transport vehicles. For purpose of explanation and illustration, and not limitation, an exemplary embodiment of the system in accordance with the invention is shown in FIG. 1 and is designated generally by reference character 10.

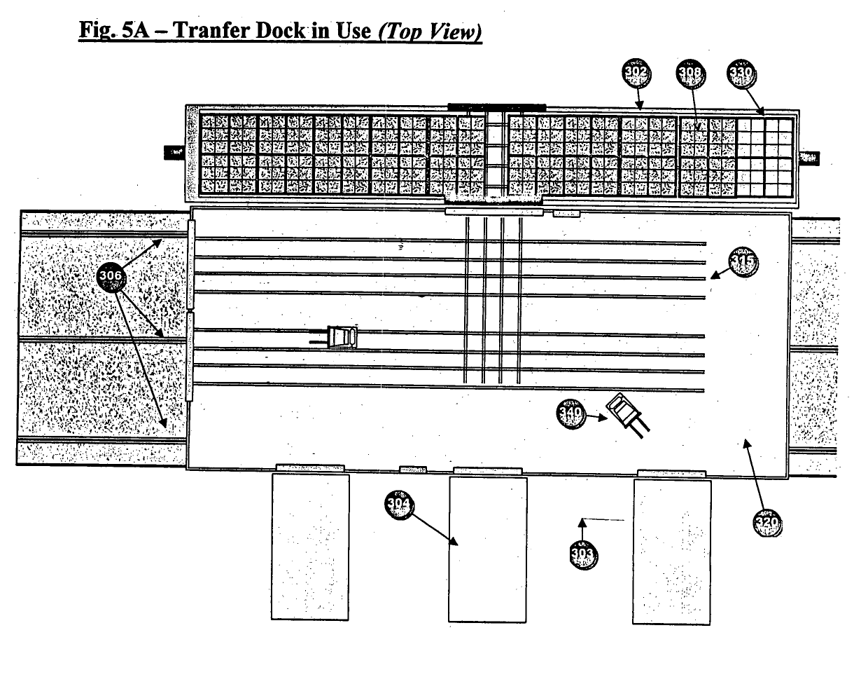

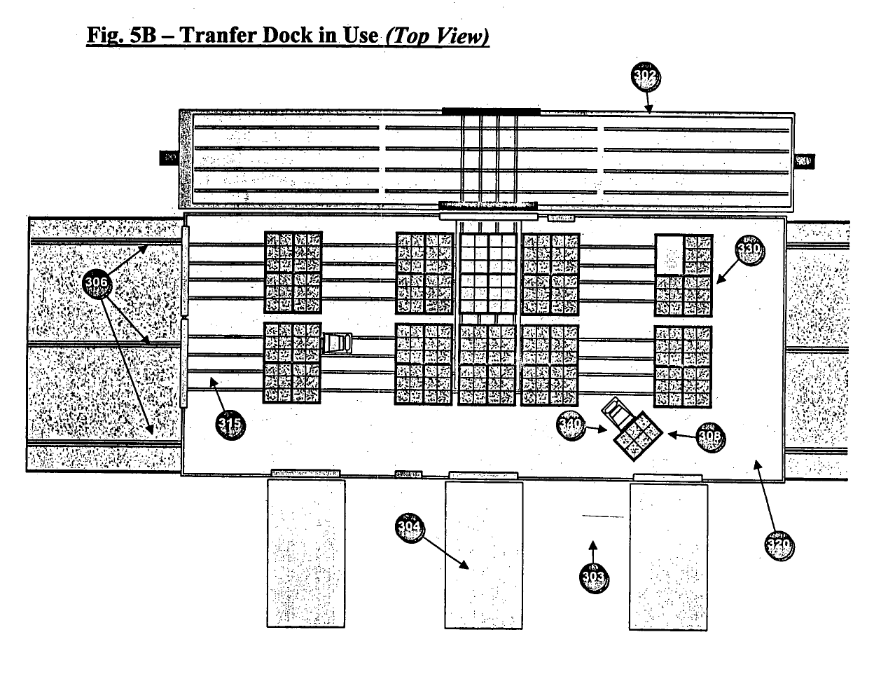

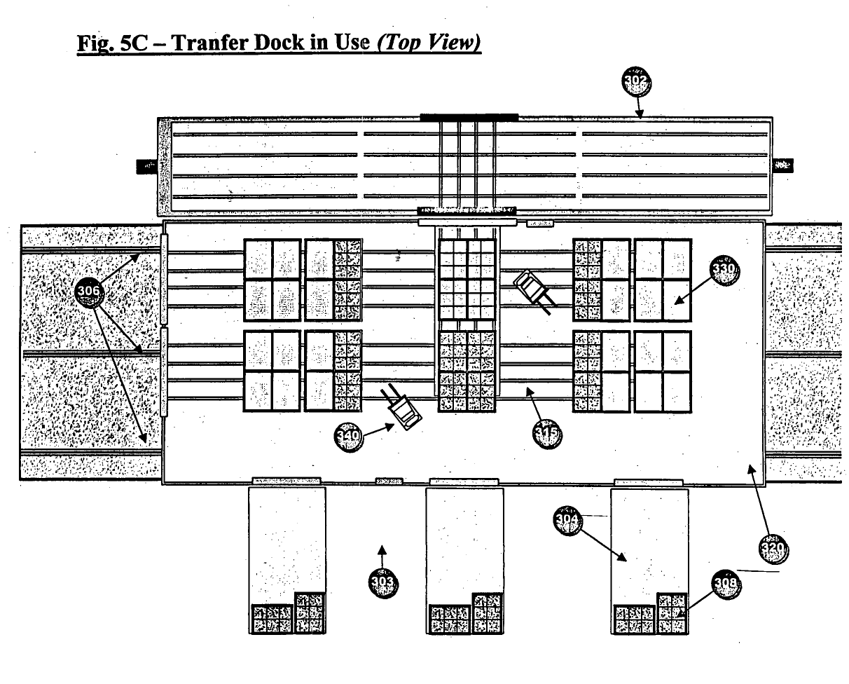

As shown in FIG. 1, the system 10 is generally described as system for centralized transfer of cargo to and from truck trailers and rail cars. The system 10 comprises a first railway 1 to accommodate rail cars 2. It will be understood that the reference to rail cars 2 may also include boxcars. In practice, the first railway 1 is likely to be any of the numerous rail lines currently used to transport goods or cargo. In addition, the first railway 1 may be a separate railway into and/or out of a loading station at some rail depot. Accordingly, the rails cars 2 may be coupled together as part of a longer train, or may be individual cars that have been decoupled and moved to a separate rail line for loading or unloading before being recoupled to the train. In addition, the rail cars 2 may be any type of rail car suitable for the transport of goods, including without limitation, refrigerated rail cars. The system 10 further comprises a staging area 3. The staging area 3 is typically a large area that abuts the rail depot to allow multiple trucks and other cargo-carrying vehicles to drive up for loading and unloading. In the present embodiment, trucks 4 back up onto the staging area 3 and unhitch their cargo-carrying trailers 5 for loading and unloading. The system 10 further comprises a second railway 6 positioned between the first railway 1 and the staging area 3 to accommodate a movable transfer dock 20. The movable transfer dock 20 will be described in further detail below. In the preferred embodiment, although not necessarily, the second railway 6 is wider than the first railway 1 and comprises two outside rails for engagement with the wheels of the transfer dock 20, and a center hot rail 7 for maintaining an electrical connection between a power source and the transfer dock 20. The transfer dock 20 is movable along the second railway 6 between trucks 4 in the staging area 3 and the appropriate rail car 2. In accordance with the present embodiment, cargo 8 is transferred via the transfer dock 20 between trucks 4 and the appropriate rail car 1. A detailed description of a transfer according to an embodiment of the present invention is provided below with reference to FIGS. 5A-5C.

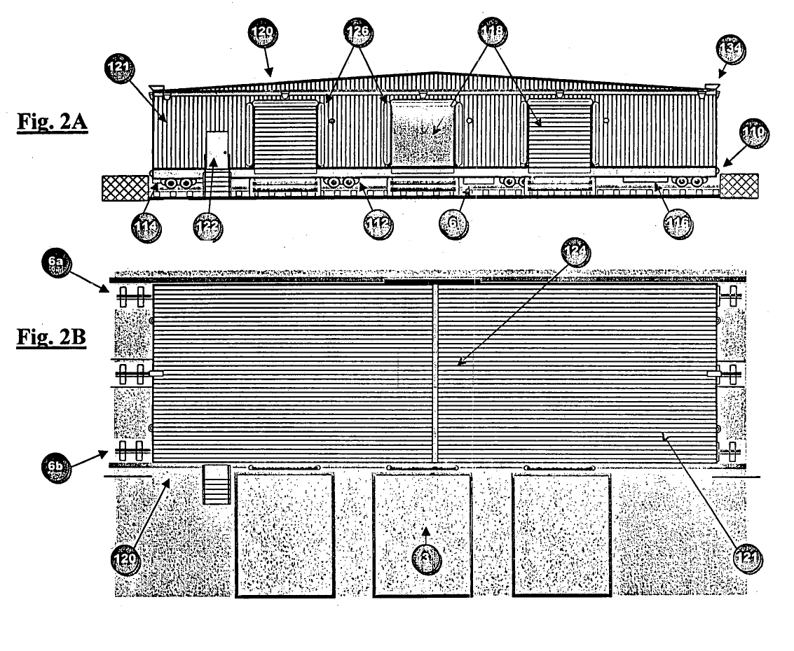

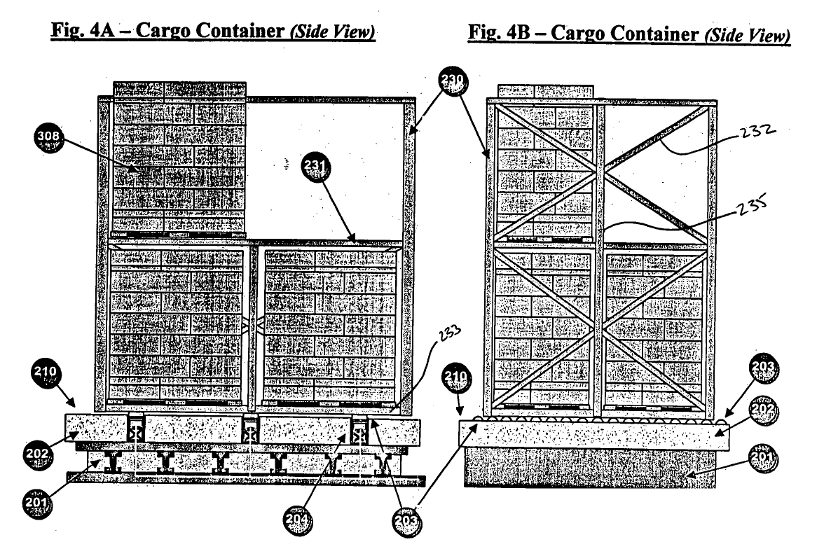

FIGS. 2A and 2B depict an embodiment of a movable transfer dock 120 in accordance with the present invention. The movable transfer dock 120 is but one embodiment of many movable transfer dock embodiments that are within the scope of the present invention and in accordance with the claims. In the present embodiment, the movable transfer dock 120 comprises a movable platform 110 having a plurality of wheels or rollers 112 thereunder to support the platform 110 on a plurality of rails 6a, 6b. In the preferred embodiment, although not necessarily, the platform 110 is approximately 80-85 feet long and 30-34 feet wide. It should be apparent, however, that the platform 110 could be built to any size, such as to accommodate the intended cargo or the space available at the transfer facility wherein it is to be used or to facilitate the efficient loading or unloading of cargo and/or cargo containers. In one embodiment, the transfer dock 120 includes a drive motor 114 mounted beneath the platform 110 for moving the transfer dock 120 along the railway 6. The drive motor 114 is coupled to some plurality of the wheels or rollers 112 via a transmission known in the art. In yet further embodiments, the transfer dock includes a pressurized air source 116, whose utility and advantages will be described in detail below with respect to FIGS. 4A and 4B.

The present embodiment of the transfer dock 120 further comprises an enclosure unit 121. The enclosure unit 121 is assembled to the platform 110 and comprises a plurality of side and end walls and a roof. The enclosure unit 121 further comprises a plurality of doors 118 receiving and depositing cargo. In the preferred embodiment, although not necessarily, the doors 118 are approximately 12-14 feet wide, depending upon whether the door 118 is to open adjacent a truck 4 or a rail car 2. Other design criteria may also be used in creating the doors 118 without limitation of the present invention. The enclosure unit 121 may also include one or more personnel doors 122 for the entry and exit of personnel working within the transfer dock 120.

In another embodiment of the transfer dock 120, the enclosure unit 121 includes a cooling unit 124 (depicted by dotted lines in FIG. 2B) such as an air conditioner or refrigeration unit. This embodiment is especially suited for the transfer of refrigerated or frozen goods between refrigerated trucks and refrigerated rail cars. In this embodiment, the entire transfer dock 120 may comprise one or more layers of insulation.

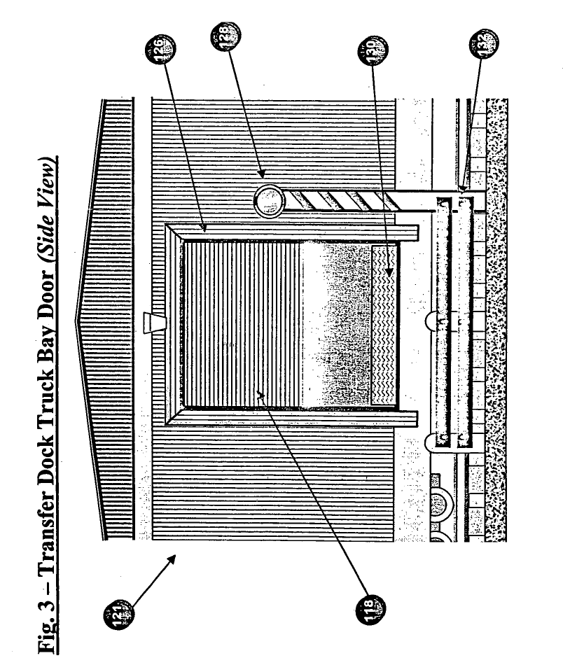

Referring to FIG. 3, to further conserve energy and maintain the temperature within the enclosure unit 121, the unit may be fitted with expandable seals 126 about the periphery of the doors 118. The expandable seals can be positioned to create a seal between the door 118 and a corresponding opening of a truck 4 or rail car 2. The curtain seals 118 can be expanded or retracted via air pressure from a pressurized air source 116. Alternatively, the curtain seals 118 may be connected to an outside pressure source at the depot wherein feeder lines running along the rails of the depot are hooked up to the transfer dock. The air pressure source 116 may also be used for charging railcar air brake systems or for pressurized car cleaning applications.

In yet further embodiments, the transfer dock 120 might include a back-up indicator 128. The back-up indicator 128 of the present embodiment includes a sensor that triggers an audible alarm if a truck 4 backs up too close to the transfer dock 120. The transfer dock 120 might also include a ramp extension 130 that may extend out from the door 118 to engage the unloading or loading end of the truck 4. The ramp extension 130 may be manually operable, or might be mechanically operable through, for example, hydraulic or pneumatic jacks or a motor. The transfer dock 120 could also include bumpers 132. In the preferred embodiment, the bumpers 132 are made of a resilient elastomeric material such as rubber and are mounted to the platform 110 in the area of the doors 118.

Referring again to FIG. 2A, the transfer dock 120 might comprise one or more video cameras 134. The video camera 134 can be, although is not necessarily, mounted onto or adjacent the exterior of the roof portion of the enclosure unit 121. The video camera 134 can be used to monitor the area surrounding the transfer dock 120 so that an operator on the inside of the enclosure unit 121 can operate the motor 114 to safely drive the transfer dock 120. The camera 134 may also be used for other safety or security purposes, such as to ensure that personnel are not on the tracks 6 in the vicinity of a moving transfer dock 120. The camera 134 could also be mounted within the enclosure unit 121 to monitor the activity of personnel while they are loading or unloading the transfer dock 120. In the preferred embodiment, the camera 134 is connected via a video connection to monitors within the enclosure unit 121. In alternative embodiments, signal may be sent from a transmitter coupled to the camera 134 to monitors at a coordinating station 9 at the transfer depot (see FIG. 1).

In alternative embodiments of the present invention, the transfer dock may be provided without an enclosure unit. Referring to FIGS. 4A and 4B, in this embodiment, the transfer dock 220 is essentially an open movable platform 210. In the preferred embodiment, the platform 210 comprises a base 201 having a top surface that includes a pre-cast concrete floor 202. The top surface floor might also be constructed of metal or some form of composite material.

In the preferred embodiment, the base 201 comprises a metal framework facilitating attachment of drive motors or other drive mechanisms and a conveyor means. The base may also include mechanisms for raising or lowering sections of or the floor 202. This ensures a level surface between the transfer dock surface and an interior railcar floor for moving specialized cargo containers in or out of the car.

In general, the transfer dock further comprises a conveyor means 203 for facilitating movement of cargo or cargo containers. In addition, according to another aspect of the invention, railcars are outfitted with the herein described conveyor means. In one embodiment, the conveyor means for facilitating comprises a plurality of intersecting runners. In further embodiments, the conveyor means might comprise a plurality of mechanized conveyors, such as conveyor belts. In yet another embodiment, the conveyor means comprises a plurality of intersecting rollers that can be selectively raised above the surface of the floor using pneumatic pressure from a pressurized air source below.

The system according to the present invention could also include the use of palletized cargo containers 230 for storing cargo. The palletized cargo containers allow maximum efficient use of space within the rail cars and on the transfer dock. In addition, the palletized cargo containers help secure loads during shipment, minimizing load damage, and provide means for stacking cargo without crushing the loads. In the preferred embodiment, the containers are configured to handle eight (8) pallets of freight with individual load dimensions of 40″×48″×60−. The pallets are stacked four (4) pallets on top of each other utilizing a secondary tier or platform 231 within the container to separate the loads. The containers are specifically adapted The containers 230 are preferably made of metal such as aluminum, iron or steel, or constructed entirely or in part using various composite materials. The containers 230 may also be coated with a protective covering for ease of cleaning and to prevent rust.

The container 230 can be configured in a variety of ways to address specific needs of the shipper and to fit a specific type of boxcar selected for shipment. The container can be constructed in a variety of ways and with a variety of materials, again depending on the specific needs of the shipper or the type of boxcar equipment used.

Basically the container is cube shaped having two side walls 232 (one not shown in FIG. 4B) to restrict the lateral motion of the palletized products during shipment. These side walls 232 face each side of the car when loaded. The other two sides of the container 230 are open to facilitate loading of palletized products on the bases 233 and one or more tiers 231 that are arranged at heights specific to the height of the palletized loads. The tier(s) 231 can be fixed or adjustable depending on load configurations and customer requirements. The top of the container 230 is open.

The two open ends of the container 230 face each end of the car when loaded. The longitudinal movement of the palletized loads 308 is restricted either by the car ends or by products in adjacent containers. In practice, a restraint device may be used at the center of the car to restrain the two centermost containers 230 and palletized loads 308 since there will be a small gap in the railcar to facilitate loading and unloading of the containers. Once this device is in place, then the containers will extend from one end of the car and will not be able to move longitudinally in the railcar.

A common floor 233 is provided as a base for the container. This is used to support and secure the two side walls 232 of the container 230, and preferably to support and secure a central cross frame 235 that is also used support and secure the side walls 232. The cross frame 235 may also used to support and secure subsequent tiers 231 for load stacking.

The bottom of the base 233 can be solid or have runner strips attached which will contact the conveyor means 203. The top of the base 233 can either be solid or grated to support the lower stack of palletized products 308. Subsequent platforms 231 can also be solid or grated depending on the product requirements.

The top of the container is open to facilitate placement of palletized loads on the uppermost tier of the container.

Generally, a standard configuration of the container will include a base 233 and a second tier comprising a platform 231 for loading of palletized products 308. The pallets will be of a standard 40″×48″ dimension and will be approximately 60″ in height when loaded with products. Four pallets will be placed on the lower tier of the container and four more on the second tier for a total of eight pallet loads per container.

Because the conveyor means 203 allows easy movement of the containers 230, it is unnecessary to access the cargo 308 directly via a forklift or other device. This minimizes potential damage to the cargo 308. In addition, the essentially open structure of the container 230 in the preferred embodiment allows greater air circulation to cool the cargo 308 in a refrigerated environment. Finally, the size of the container 230 is adapted to efficiently fit within a railcar but at the same time hold cargo pallets 308 that are adapted to fit within a truck trailer. This novel feature ensures efficiency of both rail and road transport.

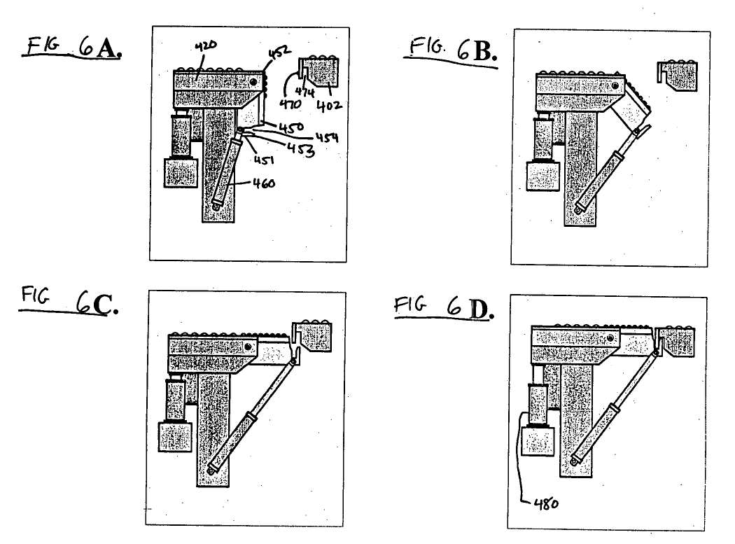

The transfer dock might also include some means for temporarily securing the transfer dock in place. In one embodiment, depicted in FIG. 6, the transfer dock might include pins that engage bores on the side of the rail cars for stabilizing the transfer dock.

Referring to FIGS. 5A-5C, the operation of an embodiment of the system of the present invention will now be described. Although the system is described herein with respect to the transfer of cargo from rail to truck, the present system is adaptable to transfer from truck to rail, or even from rail to rail without departing from the scope of the claims of the invention. In FIG. 5A, a rail car 302 is filled with cargo 308 stored in palletized cargo containers 330. Trucks 304 are awaiting loading in the staging area 303. Between the staging area 303 and the rail car 302 is a railway 306 with a movable transfer dock 320 thereon. The transfer dock 320 comprises a means 315 for facilitating movement of cargo, such as runners or rollers as described in detail above. Forklifts 340 are also available for moving the cargo 308 over the transfer dock 320.

In FIG. 5B, the palletized cargo containers 330 have been removed from the car 302 and move along the facilitating means 315 to a desired position on the transfer dock 320. Forklifts 340 remove cargo 308 from the containers 330 for loading onto the trucks 304.

In FIG. 5C, the forklifts 340 have transferred some of the cargo 308 into the trucks 304. As can be seen from this depiction, varied cargo 308 may be transported via the rail cars 302 and efficiently transferred to a plurality of trucks 304. When trucks 304 have been filled, or once car 302 has been emptied, the containers 330 can either be reloaded or moved as empties back into the rail car 302 for reverse shipment. The transfer dock 320 can then be disengaged from the rail car 302 and moved along the railway 306 to the next appropriate rail car spot for additional loading and unloading. Accordingly, efficient transfer of cargo between rail and truck is achieved.

FIGS. 6A-6D depict an embodiment of the present invention disclosing a particular means for temporarily securing the movable transfer dock to at least one of the rail cars. In this embodiment, the transfer dock 420 comprises a pivotal extension 450 connected at its distal end 451 to the transfer dock 420 via a jack 460 and pivotally connected at its opposite end 452 to the transfer dock 420. The jack 460 may be a hydraulic or pneumatic jack, or other mechanical mechanism for pivoting the pivotal extension 450. In the case of a hydraulic jack, the jack 460 is connected to the pressurized air source described above. The distal end 451 of the pivotal extension 450 also comprises a lip portion 453 which defines a groove 454 which preferably runs along the length of the outer periphery of the extension 450.

According to the preferred embodiment, the rail car 402 is outfitted with a lip portion 470 defining a groove 474 oppositely oriented to the lip portion 453 of the transfer dock 420. For instance, whereas the lip portion 453 of the transfer dock 420 defines an upwardly open groove 454 when the extension is fully pivoted, the rail car 402 has an oppositely (that is, downwardly) oriented groove 474. In this manner, the transfer dock extension lip portion 453 may be engaged in the rail car groove 474, while the rail car lip portion 470 may be engaged in the transfer dock extension groove 454.

When the transfer dock 420 is proximate the rail car 402, the jack 460 operates to pivot the extension 450 into a planar position with the top surface of the transfer dock 420 (see FIGS. 6B and 6C). Once the extension 450 is fully pivoted, another jack 480 connected to a pressure source (such as, for example, the pressurized air source described above if pneumatic jacks are utilized) raises the entire surface of the transfer dock so that the respective lip and groove portions are engaged. Thus, the transfer dock 420 is temporarily secured to the rail car 402. The process can be reversed (that is, the transfer dock 420 lowered and the extension 450 retracted) for disengaging the transfer dock 420 from the rail car 402. In alternative embodiments, the extension 450 may be provided without being pivotally connected. According to that embodiment, the lip portion and groove are thus permanently oriented for engagement with the rail car upon raising of the transfer dock 420.

It will be apparent to those skilled in the art that various modifications and variations can be made in the embodiments of the present invention without departing from the spirit or scope of the invention. Thus, it is intended that the present invention include modifications and variations that are within the scope of the appended claims and their equivalents.

What is claimed is:

1. A system for centralized transfer of cargo to and from rail cars comprising:
a first railway to accommodate the rail cars;
a staging area; and
a second railway positioned between the first railway and the staging area to accommodate a movable transfer dock;
a palletized cargo container specifically adapted for shipping cargo in a rail car comprising
a base;
two side walls extending upward from said base;
a platform secured to said side walls; and
an open top;
wherein the rail car has a conveyor means on the floor thereof;
wherein the palletized cargo container is movable on said conveyor means; and
wherein the cargo is transferred between the staging area and the rail cars via the movable transfer dock.

2. The system of claim 1 wherein the staging area is a truck loading and unloading zone.

3. The system of claim 1 wherein said rail cars are refrigerated rail cars.

4. The system of claim 1 wherein the movable transfer dock includes a means for positioning the movable transfer dock.

5. The system of claim 1 further comprising a means for temporarily securing the movable transfer dock to at least one of the rail cars.

6. The system of claim 4 wherein the movable transfer dock further comprises conveyor means for facilitating the movement of cargo.

7. The system of claim 1 wherein the movable transfer dock is a partially enclosed unit comprising a plurality of doors for receiving and depositing cargo.

8. The system of claim 7 wherein the movable transfer dock further comprises expandable curtain seals for sealing the area between at least one door and the rail cars.

9. The system of claim 1 wherein one or more of the rail cars are boxcars.

10. A cargo container system comprising:
a rail car having a conveyor means on the floor thereof;
a palletized cargo container specifically adapted for shipping cargo in a rail car, comprising:
a base;
two side walls extending upward from said base;
a platform secured to said side walls; and
an open top;
wherein the rail car has a conveyor means on the floor thereof; and
wherein the palletized cargo container is movable on said conveyor means.

11. The system of claim 10 wherein the platform is adjustable in a heightwise direction.
